(19) United States
(12) Patent Application Publication
(10) Pub. No.: US 2009/0244037 A1
(43) Pub. Date: Oct. 1, 2009

(54) IMAGE DISPLAY APPARATUS AND DRIVING METHOD OF THE IMAGE DISPLAY APPARATUS

(75) Inventor: Osamu Sagano, Inagi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/404,800

(22) Filed: Mar. 16, 2009

(30) Foreign Application Priority Data
Mar. 26, 2008 (JP) 2008-080450

(51) Int. Cl. G09G 5/00

(52) U.S. Cl. 345/204

(57) ABSTRACT

An image display apparatus is driven by a driving method including, based on a horizontal synchronizing signal, stopping an output of a modulation signal at a first timing regardless of the state of the modulation signal, shifting a row wiring, to which a selection signal is output, at a second timing, and starting the output of the modulation signal at a third timing. The first timing is performed before the second timing, whereby the image display apparatus can be stably driven against a wrong horizontal synchronizing signal.

### BACKGROUND OF THE INVENTION

1. Field of the Invention

This invention relates to an image display apparatus and a driving method of the image display apparatus.

2. Description of the Related Art

A so-called line-sequential driving method is widely used as a driving method of an image display apparatus. In this line-sequential driving method, a selection voltage is applied to a certain row wiring, and a modulation pulse corresponding to image data is applied to a column wiring side, whereby the selected row wiring is driven. Further, the row wiring to be selected is sequentially changed, whereby the entire image is displayed. In the scanning of a screen, the timing of applying the selection voltage and the timing of applying the modulation pulse are performed based on a horizontal synchronizing signal to be input.

During the driving of the image display apparatus, when noise intrudes into the horizontal synchronizing signal, or when a wrong horizontal synchronizing signal is input, the drive of a display panel may become unstable according to the timing between the horizontal synchronizing signal and driving operation. For example, when a wrong horizontal synchronizing signal is input at an interval shorter than usual, a driving voltage may become unstable. To make matters worse, the variation of the driving voltage may cause discharge between a face plate and a rear plate.

For the purpose of responding to such a disturbance of the synchronizing signal, a technique related to a flat panel display and its driving method is described in Japanese Patent Application Laid-Open (JP-A) No. 2001-134244. The object is to provide a flat panel display which has an optical modulation layer such as a liquid crystal and can perform favorable displaying free from flicker of a screen due to intrusion of noise into the synchronizing signal and erroneous conversion.

Further, in JP-A No. 2001-134244, a driving circuit part attempts to detect an abnormality of the synchronizing signal input from outside. The flat panel display is characterized in that, when the abnormality is detected, a data signal and the synchronizing signal are fixed to a specific level in a predetermined period. The abnormality of the synchronizing signal is detected by comparing the input synchronizing signal with a standard signal output from a pulse generation circuit or counting a pulse number based on input clock.

However, in the above method, means of detecting the abnormality is required to be provided, resulting in a complexity of the configuration of the image display apparatus. In addition, a process of detecting the abnormality is required to be included in the procedure of a series of driving method, resulting in a complexity of the procedure.

To favorably display an image, the image display apparatus should be stably driven. For example, JP-A No. 11-185599 discloses such a configuration that allows an image display apparatus, using an electron-emitting device, especially a surface conduction electron-emitting device, to stably emit electrons.

However, the above patent documents do not describe the case where the abnormality occurs during driving of the device, and therefore, they cannot deal with the above problems.

### SUMMARY OF THE INVENTION

This invention has been made in view of the above problems, and it is an object to provide an image display apparatus, which can be stably driven even when a horizontal synchronizing signal is erroneously input at an interval shorter than usual, and a driving method of the image display apparatus.

In order to achieve the above object, the first invention adopts a driving method of an image display apparatus. This image display apparatus includes a multi-electron source in which a plurality of electron-emitting devices are arranged in a matrix form using a plurality of row wirings and a plurality of column wirings, a scan circuit which outputs a selection signal to the row wirings to be selected, and a modulation circuit which outputs a modulation signal to the column wirings. The driving method thereof comprises the steps of: stopping the output of the modulation signal from the modulation circuit at a first timing, regardless of the state of the modulation signal; shifting the row wiring, to which the selection signal is output, at a second timing; and starting the output of the modulation signal from the modulation circuit at a third timing, wherein the first timing and the second timing are determined based on a horizontal synchronizing signal, and the first timing precedes the second timing.

Further, the second invention adopts an image display device, comprising: a multi-electron source in which a plurality of electron-emitting devices are arranged in a matrix form using a plurality of row wirings and a plurality of column wirings, a scan circuit which outputs a selection signal to the row wirings to be selected, a modulation circuit which outputs a modulation signal to the column wirings, and a timing generation circuit which outputs a signal specifying a timing, wherein the timing generation circuit outputs, based on a horizontal synchronizing signal, a first signal specifying a first timing of stopping the output of the modulation signal from the modulation circuit regardless of the state of the modulation signal, a second signal specifying a second timing of shifting the row wiring to which the selection signal is output, and a third signal starting the output of the modulation signal from the modulation circuit. And the timing generation circuit outputs the first signal before the second signal.

According to this invention, even when a horizontal synchronizing signal is input at an interval shorter than usual due to some abnormality in the driving of the image display apparatus, the image display apparatus can be stably driven.

Further features of the present invention will become apparent from the following description of exemplary embodiments with reference to the attached drawings.

### BRIEF DESCRIPTION OF THE DRAWINGS

FIG. 1 is a view showing a control timing in a first embodiment;

FIG. 2 is a block diagram showing a configuration of an image display apparatus;

FIG. 3 is block diagram showing a configuration of a drive timing generation circuit;

FIG. 4 is a view showing a control timing in a first reference example; and

FIG. 5 is a view showing a control timing in a second embodiment.

### DESCRIPTION OF THE EMBODIMENTS

Hereinafter, the preferred embodiments of this invention are described in detail in an illustrative manner with reference to the drawings. This invention is suitable for an image display apparatus which has an electron-emitting device and performs line-sequential driving. As the electron-emitting device, a field emission-type electron emitting-device, an MIM type (Metal Insulator Metal-type) electron emitting-device, and the like can be used in addition to a surface conduction electron-emitting device.

### <Configuration of Image Display Apparatus>

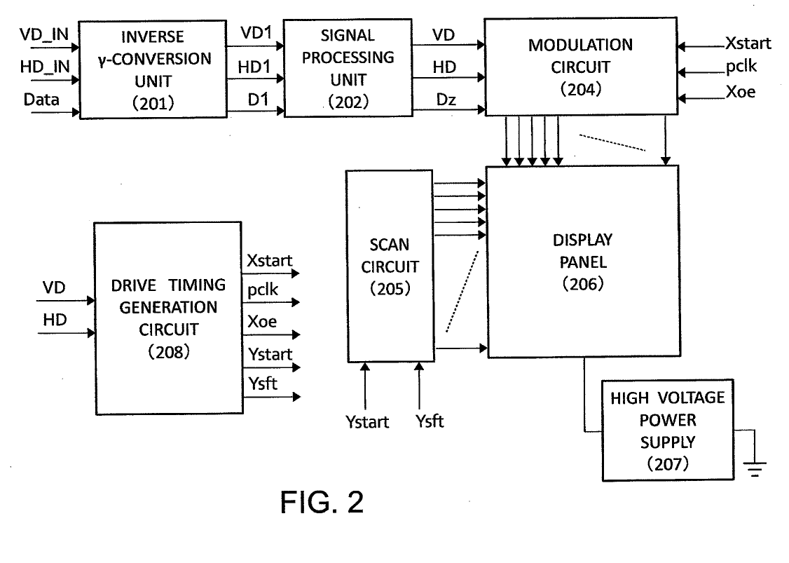

FIG. 2 is a block diagram showing the entire configuration of an image display apparatus of the present embodiment. The image display apparatus is constituted of an inverse γ-conversion unit 201, a signal processing unit 202, a modulation circuit 204, a scan circuit 205, a display panel 206, a high-voltage power supply 207, and a drive timing generation circuit 208.

The display panel 206 is a vacuum vessel constituted of a rear plate, a face plate, and a frame member and includes a spacer as a support member against atmospheric pressure. A plurality of surface conduction electron-emitting devices are arranged in a matrix form on the rear plate, and thus, a multi-electron source is provided. The face plate includes a phosphor. A more detailed method of manufacturing the display panel is described in JP-A No. 11-185599. The high-voltage power supply 207 applies a voltage to between the rear plate and the face plate, whereby the electrons emitted from the surface conduction electron-emitting device is accelerated to collide with the opposed phosphor of the face plate, and thus, an image is displayed.

The inverse γ-conversion unit 201 and the signal processing unit 202 create the image data to be displayed and a synchronizing signal in accordance with the characteristics of the display panel 206. The drive timing generation circuit 208 outputs a signal specifying the timing given to the modulation circuit 204 and the scan circuit 205 and corresponds to the timing generation circuit of this invention. The modulation circuit 204 applies a modulation signal to a column wiring. The scan circuit 205 sequentially selects a row wiring by outputting a selection signal to the row wiring. And the scan circuit 205 includes a shift resistor (not shown) corresponding to each row wiring.

### <Image Data Processing>

First, image data Data is input to the inverse γ-conversion unit 201. The image data Data represents color tone (for example, R, G, and B) in a pixel of a color video signal and is input in a point-sequential manner. The inverse γ-conversion unit 201 applies 2.2th power conversion to the input image data Data and generates image data D1 linear to brightness, a vertical synchronizing signal VD1, and a horizontal synchronizing signal HD1.

Next, the image data D1, the vertical synchronizing signal VD1, and the horizontal synchronizing signal HD1 are input to the signal processing unit 202. The signal processing unit 202 corrects the image data D1 in a non-linear manner in accordance with the light-emitting properties of the display panel to generate the corrected image data DZ.

The signal processing unit 202 further corrects the vertical synchronizing signal VD1 and the horizontal synchronizing signal HD1 in accordance with the driving system of the display panel to generate the corrected vertical synchronizing signal VD and the corrected horizontal synchronizing signal HD. For example, when the display panel is driven at a frame rate conforming to the input signal, the vertical synchronizing signal VD1 and the horizontal synchronizing signal HD1 input to the signal processing unit 202 may not be corrected. Alternatively, the length of a vertical scanning period may be rendered different for each frame in accordance with, for example, a value of the image data, or the length of a horizontal scanning period may be rendered different for each row.

Subsequently, the image data DZ is sent to the modulation circuit 204. The modulation circuit 204 obtains one line of image data and outputs the modulation signal corresponding to the image data to each column wiring.

At that time, when an Xstart signal, which is a control signal, rises, the modulation circuit 204 latches data from the shift resistor and starts pulse width modulation. In the pulse width modulation, counting is performed based on a pulse width modulation clock pclk.

Although the pulse width modulation is used in the following embodiments, the modulation method is not limited thereto. For example, pulse amplitude modulation may be used, or modulation is performed by using a step-like pulse. The modulation using the step-like pulse is described in JP-A No. 2003-316312.

### <Configuration of Drive Timing Generation Circuit>

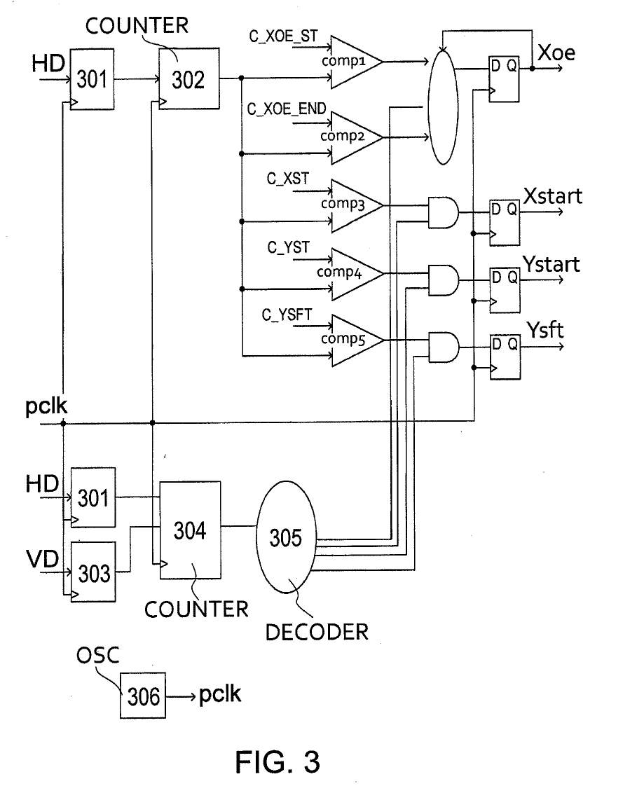

FIG. 3 is a block diagram of a configuration of a drive timing generation circuit. The drive timing generation circuit 208 outputs, for example, a signal specifying a timing in the horizontal scanning period and a timing in the vertical scanning period.

A signal specifying a timing in one horizontal scanning period (1 H) is determined by a horizontal synchronizing signal detection circuit 301, a comparator (comp 1 to comp 5), and a modulation control clock counter 302 to be output. The modulation control clock counter 302 is reset by the rising of horizontal synchronization and executes counting synchronizing with the modulation clock pclk created by an oscillator 306.

A signal specifying a timing in one vertical scanning period (1V) is determined by a vertical synchronizing signal detection circuit 303, a horizontal synchronizing frequency counter 304, and a decoder 305 to be output. The horizontal synchronizing frequency counter 304 is reset at the rising of vertical synchronization and counts up at the rising of the horizontal synchronization. The decoder 305 decodes the count value from the horizontal synchronizing frequency counter 304.

The timing in 1 H and the timing in 1V created as described above are finally gated, and output as control signals through an output flip-flop.

### <Creation of Control Signal>

The drive timing generation circuit 208 outputs control signals of Xstart, Xoe, Ystart, Ysft, and pclk. The Xstart signal controls the start of modulation by the modulation circuit 204. When Xstart=High, modulation circuit output starts. The Xoe signal turns on/off the output of the modulation circuit 204. Namely, when Xoe=High, the modulation circuit 204 outputs the modulation signal to each column wiring (enable). This step corresponds to the third timing of this invention, and this signal corresponds to the third signal of this invention. When Xoe=Low, the modulation circuit 204 immediately stops the output (disable). This step corresponds to the first timing of this invention, and this signal corresponds to the first signal of this invention. This stop operation is performed regardless of the driving state, and, for example, it is independent of whether or not the modulation signal is in output.

The Ystart signal and Ysft signal control selection of the row wiring. When Ysft =High, row shift is performed. This step corresponds to the second timing of this invention, and this signal corresponds to the second signal of this invention. Those signals are created based on the vertical synchronizing signal VD, the horizontal synchronizing signal HD, a dot clock vclk, and the pulse width modulation clock pclk.

The timing in 1 H created by the drive timing generation circuit 208 is created based on the result obtained by comparing predetermined constants with the count values from the modulation control clock counter 302 and the horizontal synchronizing frequency counter 304. The constants represent the following contents:
C_XOE_ST: timing that Xoe changes from Low to High;
C_XOE_END: timing that Xoe changes from High to Low;
C_XST: timing that Xstart is High;
C_YST: timing that Ystart is High; and
C_YSFT: timing that Ysft is High.

In this embodiment, although the count values are constants, they may be variables.

When the order of the above control signals was considered, it was found that even when the horizontal synchronizing signal was input at an interval shorter than usual, there was a preferred order of stably driving the display panel.

### Embodiment 1

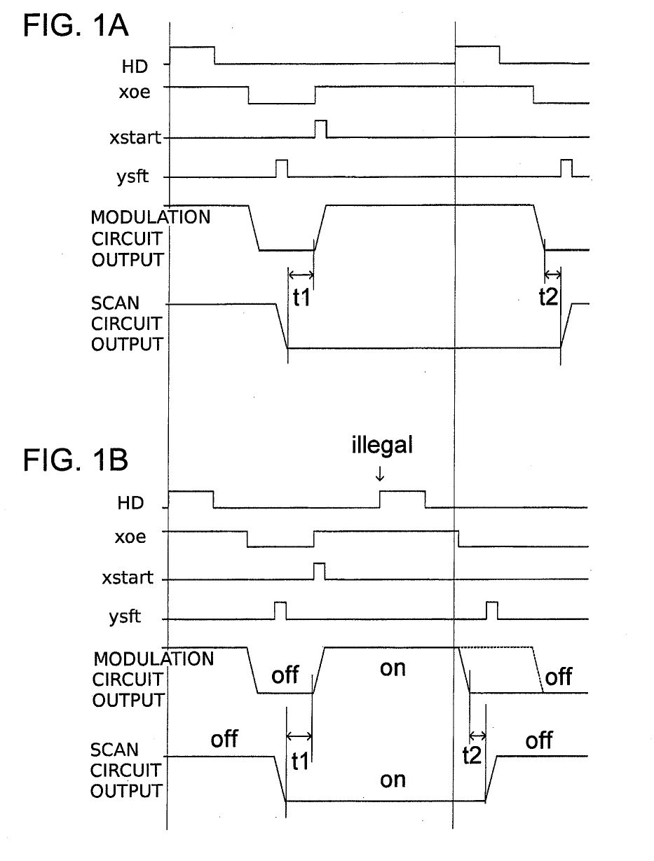

FIG. 1 is a view showing an example in which control is performed on the basis of the horizontal synchronizing signal HD in order of (1) turning off of the modulation circuit (Xoe=Low), (2) shift of a row selected by the scan circuit (Ysft=Low→High→Low), and (3) start of the pulse width modulation by the modulation circuit (Xoe=High, Xstart=High). The lateral axis represents time.

In order to perform the control in the above order, the count values are required to be set so as to satisfy the following two conditions. Namely, as the first condition, the following inequality is satisfied: C_XOE_END<C_YSFT<C_XOE_ST, C_XST. As the second condition, time t1 from shifting the scan circuit till turning on the modulation circuit, and time t2 from turning off the modulation circuit till shifting the scan circuit, respectively provide a positive time difference. The positive time difference represents the time from when a voltage is applied till when the waveform is stabilized. Although this time difference is usually about several hundred nanoseconds, the length is changed in accordance with the size of the display panel and the kind of the electron-emitting device.

FIG. 1A shows a case where the horizontal synchronizing signal is input at a normal interval, and FIG. 1B shows a case where the horizontal synchronizing signal is input at an interval shorter than usual. In this embodiment, the pulse width modulation signal is used as the waveform of the modulation circuit, and is the pulse width modulation signal obtained when the image data is maximal.

In FIG. 1B, it is found that even when the horizontal synchronizing signal (illegal) is input at an interval shorter than usual, the modulation circuit is first turned off, and then the row shift is performed. This control order is the same as the control order shown in FIG. 1A, and the drive is stable. If the selected row is shifted while the modulation circuit continues to be turned on, the drive may be unstable, or discharge may occur between the face plate and the rear plate. However, such a problem does not occur according to the drive order in this embodiment.

### Second Embodiment

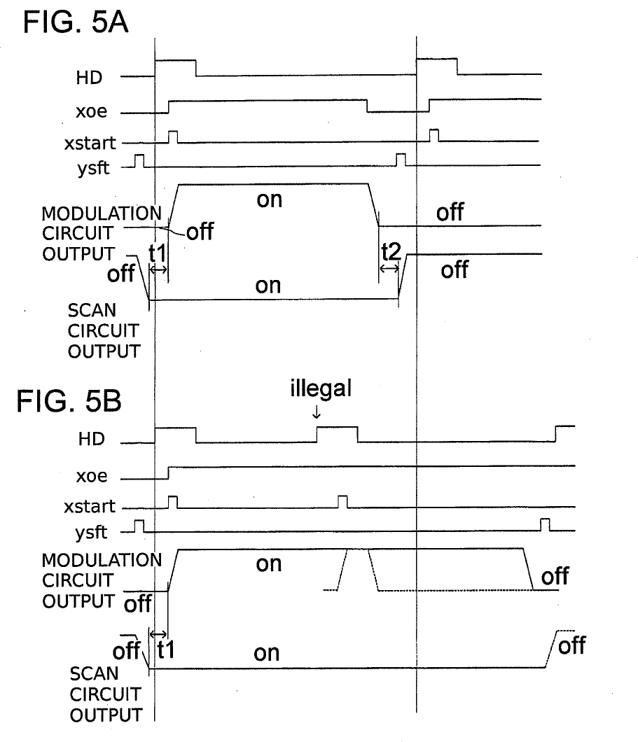

FIG. 5 is a view showing an example in which control is performed on the basis of the horizontal synchronizing signal HD in order of (1) start of the pulse width modulation by the modulation circuit (Xoe=High, Xstart=High), (2) turning off of the modulation circuit (Xoe=Low), and (3) shift of a row selected by the scan circuit (Ysft=Low→High→Low). The lateral axis represents time.

In order to perform the control in the above order, the count values are set so as to satisfy the following two conditions. Namely, as the first condition, the following inequality is satisfied: C_XOE_ST, C_XST<C_XOE_END<C_XOE_YSFT. As the second condition, as with the first embodiment, the times t1 and t2 provide a positive time difference.

FIG. 5A shows a case where the horizontal synchronizing signal is input at a normal interval, and FIG. 5B shows a case where the horizontal synchronizing signal is input at an interval shorter than usual. Also in this embodiment, the pulse width modulation signal is used as the waveform of the modulation circuit, and is the pulse width modulation signal obtained when the image data is maximal.

In FIG. 5B, the horizontal synchronizing signal (illegal) is input at an interval shorter than usual, whereby a signal for controlling the turning off of the modulation circuit (2) and the shift of the selected row (3) is not generated. Therefore, the output of the modulation circuit continues to be turned on, and thus, the row selected by the scan circuit is not shifted. Since the selected row is not shifted, problems including the instability of the drive and the occurrence of discharge do not occur.

### REFERENCE EXAMPLE

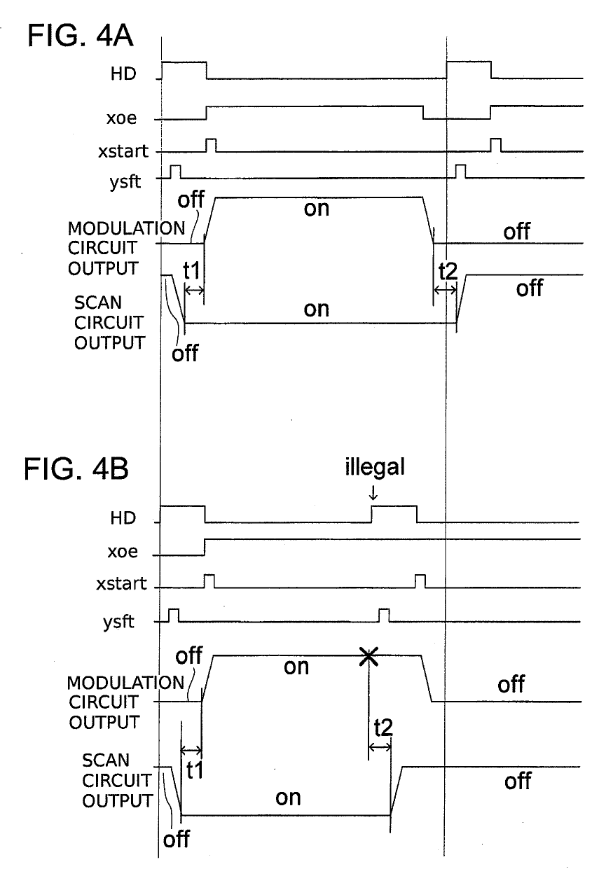

FIG. 4 is a view showing an example in which control is performed on the basis of the horizontal synchronizing signal HD in order of (1) shift of a row selected by the scan circuit (Ysft=Low→High→Low), (2) start of the pulse width modulation by the modulation circuit (Xoe=High, Xstart=High), and (3) turning off of the modulation circuit (Xoe=Low). The lateral axis represents time.

In order to perform the control in the above order, the count values are set so as to satisfy the following two conditions. Namely, as the first condition, the following inequality is satisfied: C_YSFT<C_XOE_ST, C_XST<C_XOE_END. As the second condition, as with the first and second embodiments, the times t1 and t2 provide a positive time difference.

FIG. 4A shows a case where the horizontal synchronizing signal is input at a normal interval, and FIG. 4B shows a case where the horizontal synchronizing signal is input at an interval shorter than usual. Also in this example, the pulse width modulation signal is an example of the waveform of the modulation circuit, and is the pulse width modulation signal obtained when the image data is maximal.

In FIG. 4B, the horizontal synchronizing signal (illegal) is input at an interval shorter than usual, whereby the row selected by the scan circuit is shifted in the state where the output of the modulation circuit is turned on. When the drive is performed in such a manner, due to the parasitic capacity of a matrix wiring of the display panel and inductance, the drive may become unstable, or the unstable drive may cause discharge between the face plate and the rear plate.

It can be said from the above embodiments and the reference example that the control order in the first embodiment is the most preferable. According to the first embodiment, even if there is an abnormality in the horizontal synchronizing signal, the drive sequence can be operated as well as usual, and thus, the drive is very stable. Further, the control order in the second embodiment can be said that it is preferable to prevent the instability of the drive and the occurrence of discharge.

Incidentally, this invention is not limited to the drive control circuit shown in FIG. 3. At least a circuit for counting and decoding the number of lines from the vertical synchronizing signal and a counter and decoder for counting time from the horizontal synchronizing signal may be provided, and a control signal may be transmitted by the following procedure: (1) the application of the modulation signal by the modulation circuit is stopped in response to the rising of a certain horizontal synchronizing signal; and (2) the row wiring selected by the scan circuit is shifted after a predetermined time.

According to the above procedure, even if the horizontal synchronizing signal is earlier than expected, the time difference t1 between the rising of the driving signal on the scanning side and the rising on the modulation side and the time difference t2 of the falling of the driving signal can be kept constant. Further, according to such a constitution, even when the synchronizing signal is abnormal, the stable drive can be realized without adding special circuits and processes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-080450 filed on Mar. 26, 2008, which is hereby incorporated by reference herein in their entirety.

What is claimed is:

1. A driving method of an image display apparatus, which includes a multi-electron source in which a plurality of electron-emitting devices are arranged in a matrix form using a plurality of row wirings and a plurality of column wirings, a scan circuit which outputs a selection signal to the row wiring to be selected, and a modulation circuit which outputs a modulation signal to the column wiring, comprising the steps of:
stopping the output of the modulation signal from the modulation circuit at a first timing, regardless of the state of the modulation signal;
shifting the row wiring, to which the selection signal is output, at a second timing; and
starting the output of the modulation signal from the modulation circuit at a third timing,
wherein the first timing and the second timing are determined based on a horizontal synchronizing signal, and the first timing precedes the second timing.

2. The driving method of an image display apparatus according to claim 1,
wherein the third timing is determined based on the horizontal synchronizing signal, and the third timing follows the second timing.

3. An image display apparatus, comprising:
a multi-electron source in which a plurality of electron-emitting devices are arranged in a matrix form using a plurality of row wirings and a plurality of column wirings;
a scan circuit which outputs a selection signal to the row wiring to be selected;
a modulation circuit which outputs a modulation signal to the column wiring; and
a timing generation circuit which outputs a signal specifying a timing,
wherein the timing generation circuit outputs, based on a horizontal synchronizing signal, a first signal specifying a first timing of stopping the output of the modulation signal from the modulation circuit regardless of the state of the modulation signal, a second signal specifying a second timing of shifting the row wiring to which the selection signal is output, and a third signal starting the output of the modulation signal from the modulation circuit, and the timing generation circuit outputs the first signal before the second signal.

4. The image display apparatus according to claim 3, wherein the timing generation circuit outputs the third signal after the second signal.
